(19) United States
(12) Patent Application Publication
(10) Pub. No.: US 2025/0224533 A1
(43) Pub. Date: Jul. 10, 2025

(54) Detection and Mitigation of Drilling Hazards through Time-Domain Electromagnetic Transmitters and Unmanned Aerial Vehicle Receivers

(71) Applicant: Saudi Arabian Oil Company, Dhahran (SA)

(72) Inventors: Taqi Yousuf Alyousuf, Sayhat (SA); Ersan Turkoglu, Dhahran (SA); Daniele Colombo, Dhahran (SA); Ernesto Sandoval-Curiel, Dhahran (SA)

(21) Appl. No.: 18/406,872

(22) Filed: Jan. 8, 2024

(51) Int. Cl. G01V 3/28; G01V 3/08; G01V 3/10; G01V 3/38

(52) U.S. Cl. CPC G01V 3/28; G01V 3/38; G01V 2003/085; G01V 3/10

(57) ABSTRACT

A computer implemented method that enables detection and mitigation of drilling hazards is described. The method includes determining time-domain electromagnetic parameters and obtaining data at multiple heights by at least one unmanned aerial vehicle equipped with at least one receiver as a time-domain electromagnetic transmitter emits electromagnetic radiation based on the time-domain electromagnetic parameters. The method also includes fusing the obtained data to generate a subsurface model.

### TECHNICAL FIELD

This disclosure relates generally to detection and mitigation of drilling hazards through time-domain electromagnetic (TDEM) transmitters and unmanned aerial vehicle (UAV) receivers.

### BACKGROUND

Shallow cavities can form during drilling operations. The cavities can occur near the earth's surface and can be undetected by visual inspection of the drilling location.

### BRIEF DESCRIPTION OF DRAWINGS

FIG. 1 shows a system that enables detection and mitigation of drilling hazards through time-domain electromagnetic transmitters (TDEM) and unmanned aerial vehicle (UAV) receivers.

FIG. 2 shows a workflow that enables detection and mitigation of drilling hazards through fixed portable TDEM transmitters and UAV receivers.

FIG. 3 shows subsurface Model A with two large anomalies at the surface.

FIG. 4 shows subsurface Model B with two small anomalies at the surface.

FIG. 5 shows subsurface Model C with two large anomalies at depth.

FIG. 6 shows subsurface Model D with two small anomalies at depth.

FIG. 7 shows a modeling response for subsurface Model A and subsurface Model B.

FIG. 8 shows a modeling response for subsurface Model C and subsurface Model D.

FIG. 9 illustrates the changes in forward modeling response for both subsurface Model C and subsurface Model D.

FIG. 10 shows a sensitivity analysis for receiver elevation.

FIG. 11 is a process flow diagram of a process that enables detection and mitigation of drilling hazards through fixed portable TDEM transmitters and UAV receivers.

FIG. 12 illustrates hydrocarbon production operations that include both one or more field operations and one or more computational operations, which exchange information and control exploration for the production of hydrocarbons.

FIG. 13 is a schematic illustration of an example controller (or control system) that enables detection and mitigation of drilling hazards through fixed portable TDEM transmitters and UAV receivers.

### DETAILED DESCRIPTION

In some drilling operations, the presence of unconsolidated and weak subsurface conditions pose significant risks due to the potential collapse of cavities and washouts created by the circulation of drilling fluids. These hazards can lead to equipment damage, safety incidents, and operational disruptions. Embodiments described herein relate to detection and mitigation of drilling hazards characterized by the formation of shallow cavities, sinkholes, and other subsurface anomalies. In some embodiments, a combination of Time-Domain Electromagnetic (TDEM) techniques and Unmanned Aerial Vehicles (UAVs) are used to facilitate efficient and accurate hazard detection and mitigation of drilling hazards.

Some advantages of the present techniques include an improvement to drilling operations by reducing risks to personnel and equipment, minimizing operational disruptions, and improving well placement decisions. Beyond drilling operations, the present techniques can be implemented in applications such as environmental monitoring, infrastructure assessment, and resource exploration.

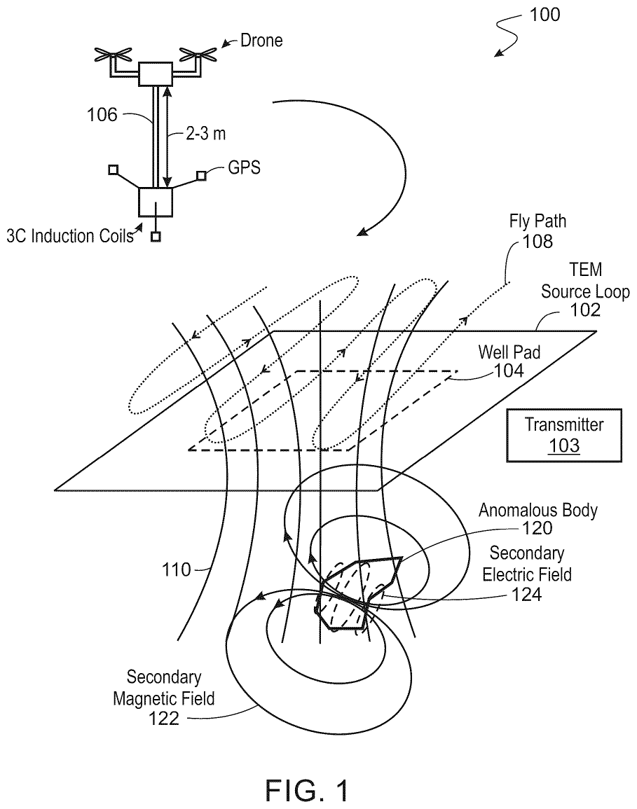

FIG. 1 shows a system 100 that enables detection and mitigation of drilling hazards through time-domain electromagnetic transmitters and unmanned aerial vehicles receivers. Arid geological settings often include shallow cavities at or near the surface. These hazards can lead to well instability, equipment damage, and safety incidents. Arid environments with specific geological conditions are prone to dissolution and formation of shallow cavities, also known as sinkholes, karsts collapses, and the like. These cavities can be voids (e.g., empty space) or filled with different types of loose sediments by the circulation of water and deposition from rubble deriving from the collapse of the hosting rock formations. Such unconsolidated and weak conditions pose a drilling hazard during the drilling operations due to circulation of water at high pressure and vibration. This can produce washouts that trigger sudden collapses that place rig operations at risk.

The system 100 uses TDEM techniques in arid environments, complemented by UAVs for dynamic data acquisition that enables avoidance of shallow cavities and the resulting sudden collapses that place rig operations at risk. This synergy creates a robust solution for identifying drilling hazards (e.g., cavities) and ensuring safe and informed drilling operations. As shown in FIG. 1, a fixed, portable, transient electromagnetic (TEM) source loop 102 is positioned on the earth's surface. The TEM source loop 102 is generated by a TDEM transmitter 103. In the example of FIG. 1, the TEM source loop 102 is positioned above or near a well pad 104. The well pad 104 is an area in which permanent operations for oil and gas production take place. In examples, the well pad 104 includes that portion of the pad area occupied within drilling rig anchors. One or more UAV-based receivers 106 flies above the TEM source loop 102 and the well pad 104. In some embodiments, the UAV-based receiver 106 flies along a flight path 108, and captures electromagnetic radiation 110 generated in response to the TEM source loop 102. The electromagnetic radiation 110 is reflected from structures and formations that occur at the Earth's surface or subsurface.

In examples, the fixed, portable, TDEM transmitter 103 is strategically positioned on the surface. The TDEM transmitter 103 is portable in that it can be positioned at various locations on the Earth's surface. In examples, the TDEM transmitter 103 is ported to a predetermined location and fixed onto the Earth's surface at the predetermined location. The TDEM transmitter 103 emits transient electromagnetic pulses into the subsurface without galvanic contact. The TDEM transmitter 103 is mobile, which enables targeted surveys in areas of potential drilling hazards, facilitating adaptable data acquisition. It generates a high intensity electromagnetic induction around the targeted investigation area within the transmitter loop (e.g., TEM source loop 102). The subsurface response (e.g., the secondary magnetic field 122) to the electromagnetic radiation 110 (e.g., primary magnetic field) is recorded via a UAV mounted receiver 106 at varying positions and altitudes. In the example of FIG. 1, an anomalous body 120 causes the emission of a secondary magnetic field 122 in response to the electromagnetic radiation 110. In examples, the anomalous body is a shallow cavity. Within the anomalous body 120, a secondary electric field 124 occurs that drives the generation of the secondary magnetic field 122 in response to the electromagnetic radiation 110. The UAV based receivers 106 are employed to capture the secondary magnetic field 122 generated by the anomalous body 120. These UAV-mounted receivers offer versatility in data collection, allowing for coverage over hazardous and inaccessible terrains and can be flown at different altitudes. In examples, the anomalous body corresponds to predetermined geophysical signatures as determined by the secondary magnetic field 122 as captured by the UAV 106. One or more pre-trained machine learning models is used to determine the anomalous body (e.g., shallow cavity) present in the Earth's subsurface based on, at least in part, the secondary magnetic field.

In some embodiments, the data captured by the UAV based receivers 106 is used for real-time monitoring and data analysis. Collected data from UAV-based receivers is transmitted in real-time to a processing unit, such as a central processing unit (CPU). Algorithms are used to analyze the data to detect anomalies indicative of potential drilling hazards. This real-time aspect enables proactive hazard prevention and facilitates timely decision-making. The fixed geometry of the survey design allows pre-training of machine learning models for real time prediction of the potential drilling hazards related to sinkholes by image-based machine learning algorithms.

The type of near surface conditions that are prone to drilling hazards typically present anomalous geophysical signatures for the electric resistivity. In examples, a shallow cavity presents anomalous geophysical signatures in a secondary magnetic field generated by the shallow cavity. Additionally, in examples, the geophysical signatures are (resistivity-velocity cross-plots). Anomalous sites can be classified as high-risk zones for drilling operations. On the other hand, some shallow cavities, such as sinkholes, may not be distinguished from the host environment due to their smaller size or consolidated filling and continue to pose a drilling hazard risk. Therefore, geohazard monitoring is performed during the drilling operations to identify sinkholes developed during drilling.

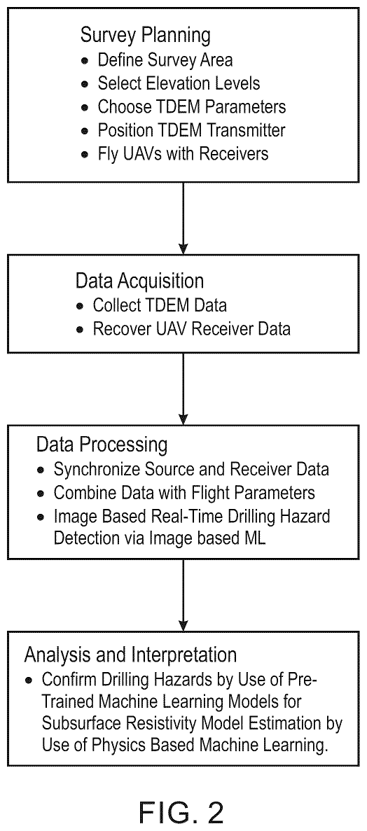

FIG. 2 is a workflow 200 that enables detection and mitigation of drilling hazards through fixed portable TDEM transmitters and UAV receivers.

At block 202, survey planning is performed. Survey planning involves defining the survey area and selecting elevation levels. In examples, at least one elevation level for data capture is assigned to each respective UAV receiver. TDEM parameters are defined. In examples, TDEM parameters include transmitter area, receiver area, current, grid cell size, and recorded time gates. In examples, transmitter area refers to an area where the generated electromagnetic radiation occurs. In examples, transmitter area refers to an area defined by the TEM source loop. Additionally, in examples the receiver area refers to an area where data capture by the receiver occurs. In examples, recorded time gates refers to timing information associated with the TDEM transmitter. In some embodiments, the TDEM transmitter is positioned and TDEM parameters are defined or recorded.

At block 204, data acquisition occurs. During data acquisition, the TDEM transmitter drives current though the TEM source loop, TDEM data and parameters are collected, and UAV receiver data is recovered.

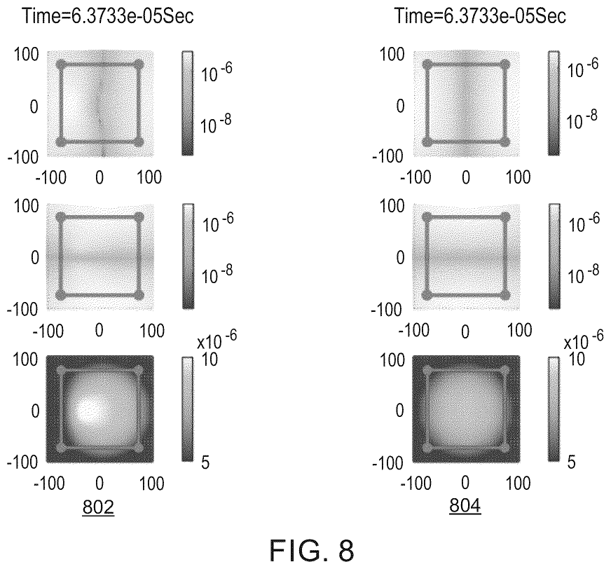

At block 206, data processing is performed. Source and receiver data are synchronized. The acquired data is combined with flight parameters. Image based real-time drilling hazard detection is performed via an image based machine learning model. In image-based real time drilling hazard detection using a machine learning model, the inputs and outputs are structured using time series data. For example, the input to the machine learning model is time-series image data that includes db/dx, db/dy/, and db/dz as shown in FIG. 8. In examples, the time-series image data includes the changes in the x, y, and z components of the primary magnetic field and secondary magnetic field. The captured data is converted into images that show changes in the x, y, and z components of the primary magnetic field and secondary magnetic field. The output of the trained machine learning model is real-time hazard prediction (e.g., a location, shape, and size of an anomalous body is predicted). If a hazard is predicted, the system generates alerts or notification to inform drilling operators. These alerts may trigger safety protocols or prompt necessary adjustments in drilling operations.

In examples, real-time image-based detection of potential drilling hazards is performed using an image that captures a three component (e.g., x, y, z) secondary magnetic field response from the Earth's surface and subsurface captured at varying altitudes. The TDEM transmitter generates a primarily vertical magnetic field (e.g., electromagnetic radiation 110 of FIG. 1) covering the entire survey area. The secondary magnetic field (e.g., secondary magnetic field 122 of FIG. 1) generated by the surface and subsurface is used to create three component secondary magnetic field response maps. In examples, the field response map is an image that is input to the trained machine learning model.

At block 208, analysis and interpretation is performed. Drilling hazards are confirmed using pre-trained machine learning models for subsurface resistivity model estimation. The pre-trained machine learning models may be, for example, physics based machine learning models. In examples, the drilling hazard is confirmed by predicting a location of the anomaly. The electromagnetic field measurements (db/dx/, db/dy/ and db/dz), are input to a pre-trained machine learning model that outputs a 3D resistivity model of the Earth's surface and subsurface. The 3D resistivity model shows shallow cavities as areas of changed resistivity.

Once the survey is completed, inversion of the captured TDEM data can be achieved either by conventional gradient based local optimizations or emerging physics-based machine learning models. Analysis and interpretation focuses on interpreting the subsurface models to identify drilling hazards and make safety recommendations. Inversion of the captured TDEM data is the process of recovering the subsurface resistivity model. The captured TDEM data includes the response of the subsurface to electric and electromagnetic field flow. The responsive physical parameter is electrical resistivity. Inversion of the captured TDEM data recovers the underlying resistivity structure of the subsurface.

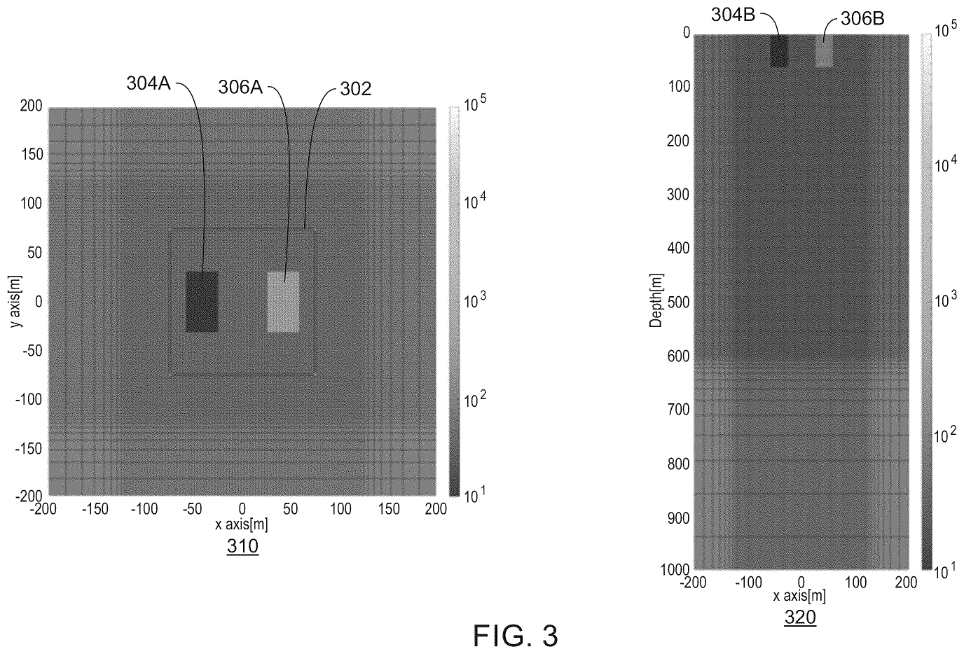

In some embodiments, the resulting data forms a subsurface model that identifies shallow cavities. FIGS. 3-6 show the use of multiple models with varying characteristics that enable assessment of the effectiveness and sensitivity of the generated subsurface models across different scenarios.

FIG. 3 shows subsurface Model A with two large anomalies at the surface. In a top view 310, a large anomaly 304A and a large anomaly 306A are shown. In a cross section view 320, a large anomaly 304B and a large anomaly 306B are shown. The large anomaly 304A in the top view 310 corresponds to the large anomaly 304B in the cross section view 320. The large anomaly 306A in the top view 310 corresponds to the large anomaly 306B in the cross section view 320. A grid 330 is shown in the top view 310 and cross section view 320 as a network of spaced horizontal and vertical lines that are used to identify surface and subsurface locations. The top view 310 shows transmitter loop geometry 302, a 150 m×150 m loop source. As an example, the two large anomalies 304A/304B and 306A/306B each measure 35 meters by 70 meters, positioned at a depth of 0 meters below the Earth's surface. Subsurface Model A shows the detection of a significant anomaly directly beneath the surface. It represents a scenario where a large void or cavity could pose a significant drilling hazard.

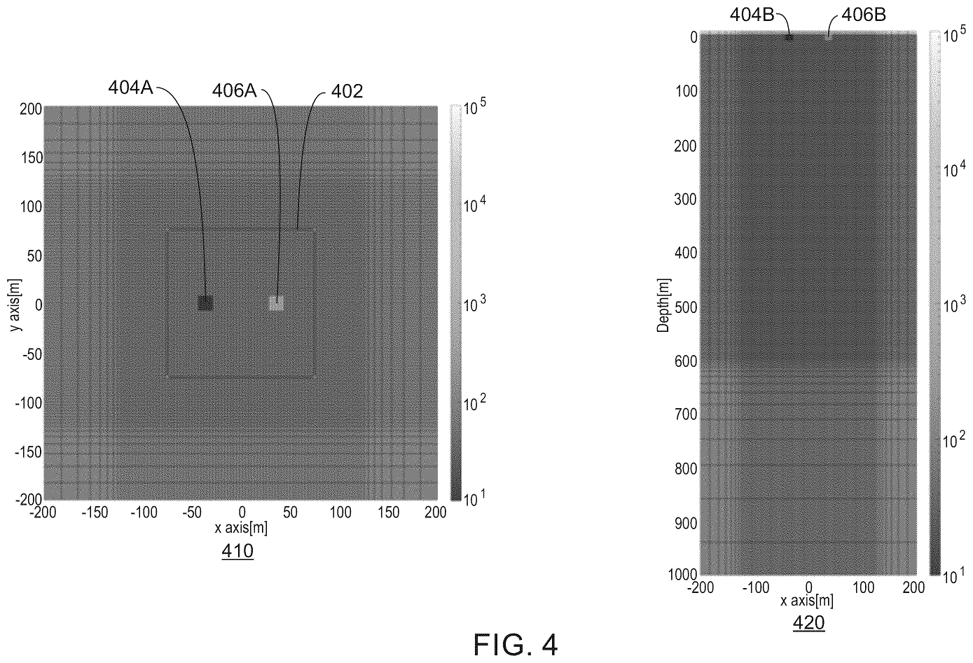

FIG. 4 shows subsurface Model B with two small anomalies at the surface. In a top view 410, a small anomaly 404A and a small anomaly 406A are shown. In a cross section view 420, a small anomaly 404B and a small anomaly 406B are shown. The small anomaly 404A in the top view 410 corresponds to the small anomaly 404B in the cross section view 420. The small anomaly 406A in the top view 410 corresponds to the small anomaly 406B in the cross section view 420. A grid 430 is shown in the top view 410 and cross section view 420 as a network of spaced horizontal and vertical lines that are used to identify surface and subsurface locations. The top view 410 shows transmitter loop geometry 402, a 150 m×150 m loop source. As an example, the two small anomalies 404A/404B and 406A/406B each measure 25 meters by 25 meters, located at a depth of 0 meters (surface). Subsurface Model B shows the detection of multiple smaller anomalies close to the surface. Such conditions mimic areas where drilling hazards might exist due to the presence of voids or weak formations.

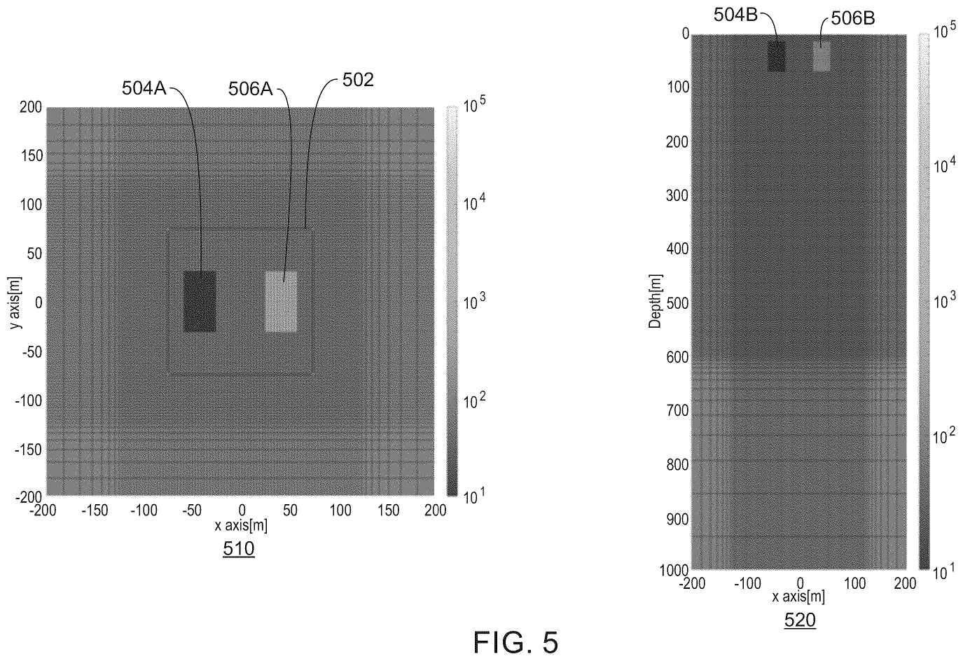

FIG. 5 shows subsurface Model C with two large anomalies at depth. In a top view 510, a large anomaly 504A and a large anomaly 506A are shown. In a cross section view 520, a large anomaly 504B and a large anomaly 506B are shown. The large anomaly 504A in the top view 510 corresponds to the large anomaly 504B in the cross section view 520. The large anomaly 506A in the top view 510 corresponds to the large anomaly 506B in the cross section view 520. A grid 530 is shown in the top view 510 and cross section view 520 as a network of spaced horizontal and vertical lines that are used to identify surface and subsurface locations. The top view 510 shows transmitter loop geometry 502, a 150 m×150 m loop source. As an example, the two large anomalies 504A/504B and 506A/506B each measure 35 meters by 70 meters and are positioned at a depth of 25 meters from the Earth's surface. Subsurface Model C shows anomalies that are not directly under the surface but are situated at a deeper level. This is used in scenarios where drilling hazards exist further down in the subsurface.

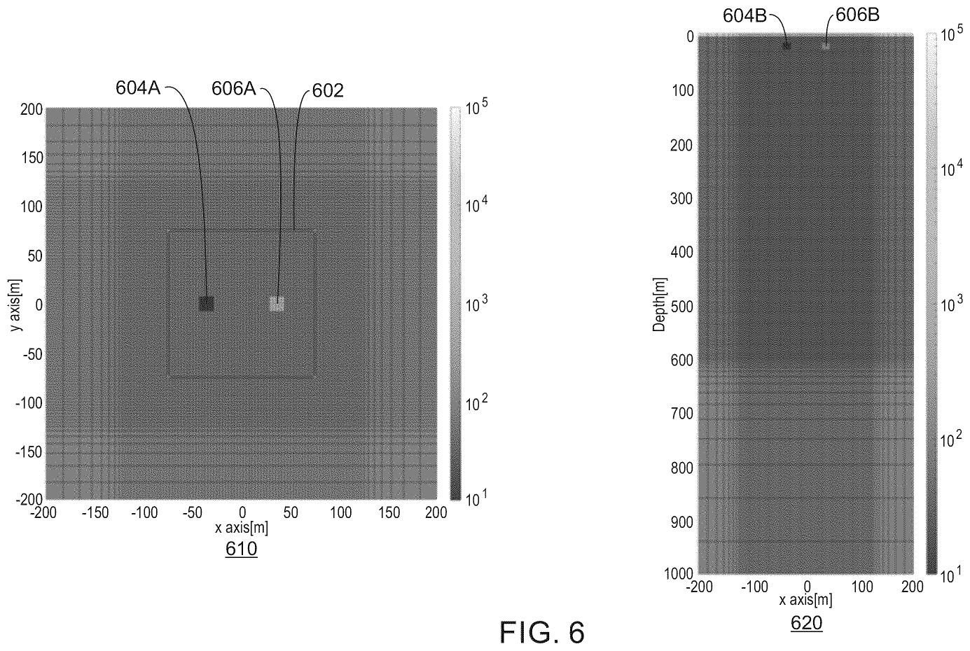

FIG. 6 subsurface Model D with two small anomalies at depth. In a top view 610, a small anomaly 604A and a small anomaly 606A are shown. In a cross section view 620, a small anomaly 604B and a small anomaly 606B are shown. The small anomaly 604A in the top view 610 corresponds to the small anomaly 604B in the cross section view 620. The small anomaly 606A in the top view 610 corresponds to the small anomaly 606B in the cross section view 620. A grid 630 is shown in the top view 610 and cross section view 620 as a network of spaced horizontal and vertical lines that are used to identify surface and subsurface locations. The top view 610 shows transmitter loop geometry 602, a 150 m×150 m loop source. As an example, the two small anomalies 604A/604B and 606A/606B each measure 25 meters by 25 meters, but they are located at a depth of 25 meters. Subsurface Model D shows the identification of smaller anomalies at greater depths, which can be used to assess drilling hazards in deeper formations.

The subsurface models of FIGS. 3-6 show models generated according to the present technique under various conditions. Various TDEM parameters can be defined to generate the subsurface models. As an example, consider simulated square loop sources located on the surface with a linear ramp turn-off function that switches off the current from 1 A to 0 A in 1 μs. In examples, a measurement site (e.g., a well pad or other location) is discretized into grid of cells in varying sizes. In examples, the TDEM parameters include grid cell size. The size of the grid cells varies based on a distance from the center of the grid, where TDEM parameters capture is concentrated. In FIGS. 3-6, respective grids and grid cells are shown on the subsurface models.

Accordingly, in some embodiments, grid cells are defined at a measurement site and the time derivative of the horizontal and vertical components of the magnetic field (dbx/dt, dby/dt, dbz/dt) are calculated at 30 log-spaced time channels covering a time interval from 1 μs to 1 ms. The grid size in the x-direction and y-direction is 143 grid cells each, and the z-direction is 263 grid cells. The central region of the grid, where TDEM measurements are concentrated, is discretized by uniform cells of size 3 meters in all three directions. Outside of a central region of the grid, the grid cell sizes decrease in size as a distance from the center of the grid increases. In examples, the central region of the grid is a TDEM parameter.

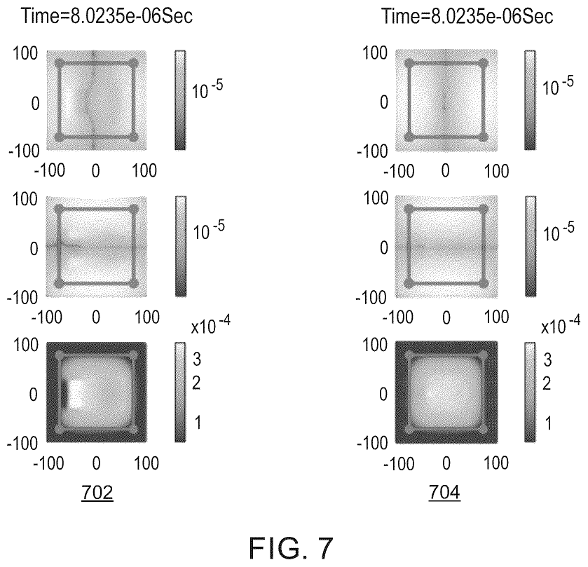

FIG. 7 shows a modeling response for subsurface Model A and subsurface Model B. The forward modeling response for TDEM subsurface Model A is shown at 702, and subsurface Model B at 704. Rows 1-3 correspond to dbx/dt, dby/dt, and dbz/dt respectively at time gate of 8 μs. Transmitter is located at 0 m depth. FIG. 7 presents a forward modeling response for TDEM subsurface Model A of FIG. 3, showcasing the electromagnetic field components dbx/dt, dby/dt, and dbz/dt at a specific time channel. These responses show the anomalies' (e.g., shallow cavities, sinkholes, karsts, etc.) influence on the electromagnetic field.

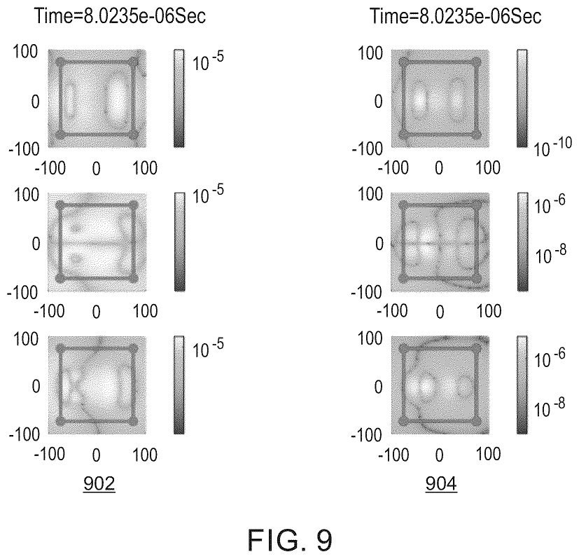

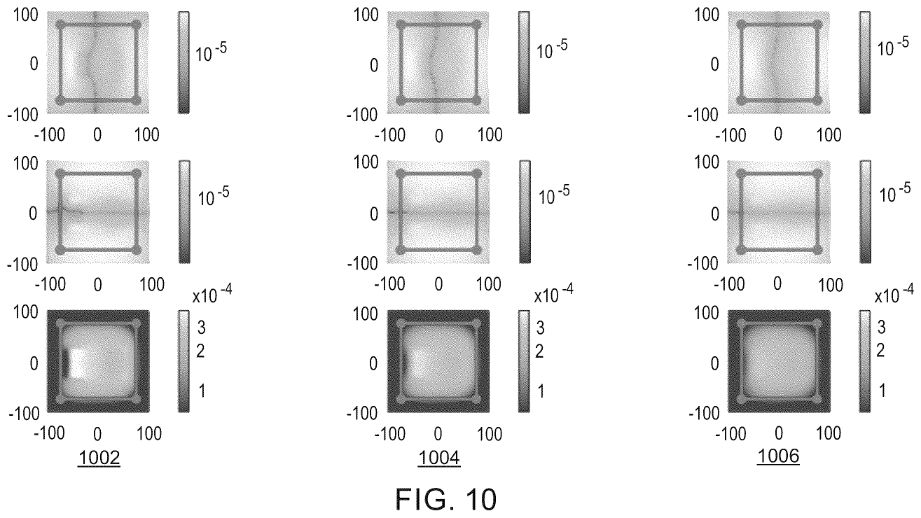

FIG. 8 shows a modeling response for subsurface Model C and subsurface Model D. The forward modeling response for TDEM subsurface Model C is shown at 802, and subsurface Model D at 804. Rows 1-3 correspond to dbx/dt, dby/dt, and dbz/dt respectively at time channels at 60 μs. Transmitter is located at 0 m depth. FIG. 8 presents the forward modeling response for TDEM subsurface Model C of FIG. 5, highlighting the electromagnetic field components at a later time channel. FIG. 8 shows the discernment of anomalies in varying geological conditions, even at significant depths. Furthermore, FIG. 9 shows changes in a modeling response for subsurface Model C and subsurface Model D. FIG. 9 illustrates the changes in forward modeling response for both subsurface Model C of FIG. 5 at 902, and subsurface Model D of FIG. 6 at 904 when compared to a homogeneous background model. Rows 1-3 correspond to changes in dbx/dt, dby/dt, and dbz/dt respectively at time gate of 8 μs. Transmitter is located at 0 m depth. This visual comparison emphasizes the anomalies' distinctive electromagnetic signatures and their potential as indicators of subsurface hazards. FIG. 10 shows the forward modeling response for TDEM subsurface Model A of FIG. 3. Rows 1-3 correspond to dbx/dt, dby/dt, and dbz/dt, respectively, at time channels at 8 μs. Columns 1-3 correspond to receiver elevations of 0 m (1002), 5 m (1004), and 10 m (1006), respectively. As shown in FIG. 10, the sensitivity analysis for receiver elevation demonstrates the technology's adaptability and responsiveness. As the receiver elevation increases, the electromagnetic responses attenuate faster, showing the ability to detect anomalies at different depths.

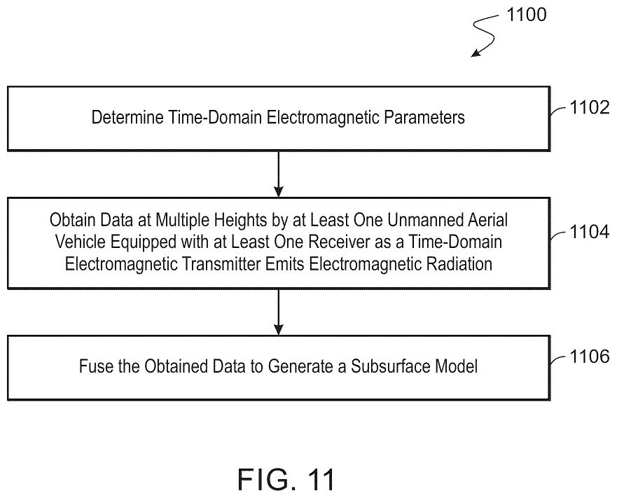

FIG. 11 is a process flow diagram of a process 1100 that enables detection and mitigation of drilling hazards through fixed portable TDEM transmitters and UAV receivers.

At block 1102, time-domain electromagnetic parameters are determined. In examples, time-domain electromagnetic parameters include transmitter area, receiver area, current, grid cell size, and recorded time gates. In examples, the determined time-domain electromagnetic parameters are implemented by the time-domain electromagnetic transmitter during data capture.

At block 1104, data is obtained by at least one unmanned aerial vehicle equipped with at least one receiver as a time-domain electromagnetic transmitter emits electromagnetic radiation. The time-domain electromagnetic transmitter emits electromagnetic radiation according to the determined time-domain electromagnetic parameters during data capture. The unmanned aerial vehicle equipped with at least one receiver is configured to capture data at various heights above the surface, where the data is associated with the time-domain electromagnetic transmitter. In examples, the captured TDEM data includes primary magnetic fields (e.g., generated by the time-domain electromagnetic transmitter), secondary magnetic fields (e.g., responses generated by anomalous bodies), realized time-domain electromagnetic parameters (actual parameter values realized during data capture).

The obtained data is converted into images that show changes in components of magnetic fields. In examples, the obtained data is processed using image-based real-time drilling hazard detection via an image based machine learning model to generate the subsurface model.

At block 1106, the obtained data is fused to generate a subsurface model. In examples, drilling hazards are confirmed using pre-trained machine learning models for subsurface resistivity model estimation, where physics based machine learning is applied.

By combining TDEM methods and UAV-based data acquisition, the present techniques enable an environmentally friendly, non-invasive, and real-time approach to safeguarding drilling operations. The ability to identify potential hazards early, make informed well-placement decisions, and minimize equipment damage contributes to safer and more efficient drilling practices. The innovative integration of geophysical methods, UAVs, and advanced computational techniques establishes a new standard in drilling hazard assessment and prevention.

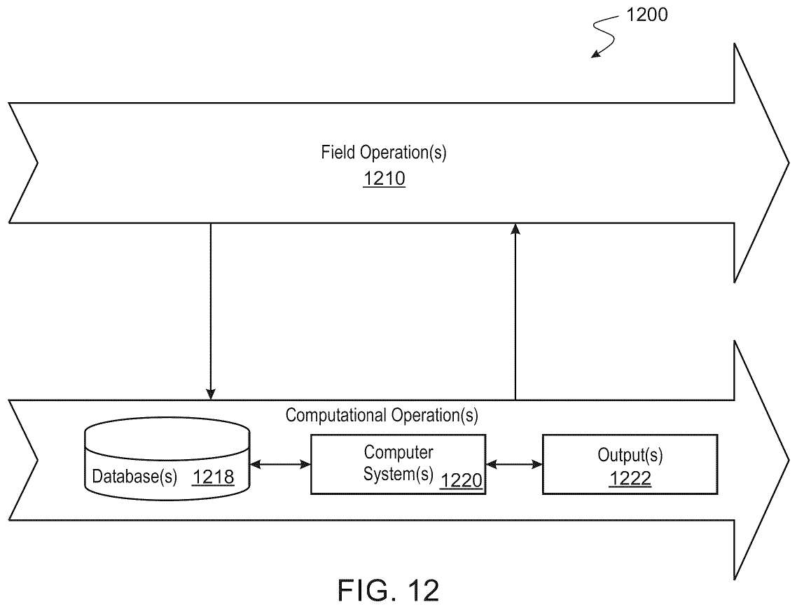

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

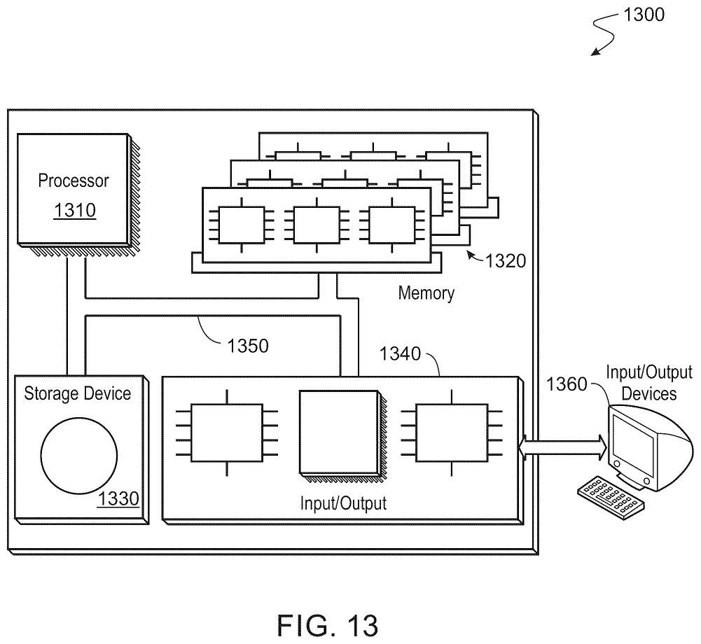

FIG. 13 is a schematic illustration of an example controller 1300 (or control system) that enables detection and mitigation of drilling hazards through fixed portable TDEM transmitters and UAV receivers. For example, the controller 1300 may be operable according to the workflow 200 of FIG. 2 or the process 1100 of FIG. 11. In some embodiments, the controller 1300 is the same as or similar to the computer systems 1220 of FIG. 12. The controller 1300 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1300 includes a processor 1310, a memory 1320, a storage device 1330, and an input/output interface 1340 communicatively coupled with input/output devices 1360 (for example, displays, keyboards, measurement devices, sensors, valves, pumps). Each of the components 1310, 1320, 1330, and 1340 are interconnected using a system bus 1350. The processor 1310 is capable of processing instructions for execution within the controller 1300. The processor may be designed using any of a number of architectures. For example, the processor 1310 may be a CISC (Complex Instruction Set Computers) processor, a RISC (Reduced Instruction Set Computer) processor, or a MISC (Minimal Instruction Set Computer) processor.

In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output interface 1340.

The memory 1320 stores information within the controller 1300. In one implementation, the memory 1320 is a computer-readable medium. In one implementation, the memory 1320 is a volatile memory unit. In another implementation, the memory 1320 is a nonvolatile memory unit.

The storage device 1330 is capable of providing mass storage for the controller 1300. In one implementation, the storage device 1330 is a computer-readable medium. In various different implementations, the storage device 1330 may be a floppy disk device, a hard disk device, an optical disk device, or a tape device.

The input/output interface 1340 provides input/output operations for the controller 1300. In one implementation, the input/output devices 1360 includes a keyboard and/or pointing device. In another implementation, the input/output devices 1360 includes a display unit for displaying graphical user interfaces.

There can be any number of controllers 1300 associated with, or external to, a computer system containing controller 1300, with each controller 1300 communicating over a network. Further, the terms “client,” “user,” and other appropriate terminology can be used interchangeably, as appropriate, without departing from the scope of the present disclosure. Moreover, the present disclosure contemplates that many users can use one controller 1300 and one user can use multiple controllers 1300.

### Embodiments/Examples

According to some non-limiting embodiments or examples, provided is a computer-implemented method that enables detection and mitigation of drilling hazards, including: determining, using at least one hardware processor, time-domain electromagnetic parameters; obtaining, using the at least one hardware processor, data at multiple heights by at least one unmanned aerial vehicle equipped with at least one receiver as a time-domain electromagnetic transmitter emits electromagnetic radiation based on the time-domain electromagnetic parameters; and fusing, using the at least one hardware processor, the obtained data to generate a subsurface model.

According to some non-limiting embodiments or examples, provided is an apparatus including a non-transitory, computer readable, storage medium that stores instructions that, when executed by at least one processor, cause the at least one processor to perform operations including: determining time-domain electromagnetic parameters; obtaining data at multiple heights by at least one unmanned aerial vehicle equipped with at least one receiver as a time-domain electromagnetic transmitter emits electromagnetic radiation based on the time-domain electromagnetic parameters; and fusing the obtained data to generate a subsurface model.

According to some non-limiting embodiments or examples, provided is a system, including: one or more memory modules; one or more hardware processors communicably coupled to the one or more memory modules, the one or more hardware processors configured to execute instructions stored on the one or more memory models to perform operations including: determining time-domain electromagnetic parameters; obtaining data at multiple heights by at least one unmanned aerial vehicle equipped with at least one receiver as a time-domain electromagnetic transmitter emits electromagnetic radiation based on the time-domain electromagnetic parameters; and fusing the obtained data to generate a subsurface model.

Further non-limiting aspects or embodiments are set forth in the following numbered embodiments:

Embodiment 1: A computer-implemented method that enables detection and mitigation of drilling hazards, including: determining, using at least one hardware processor, time-domain electromagnetic parameters; obtaining, using the at least one hardware processor, data at multiple heights by at least one unmanned aerial vehicle equipped with at least one receiver as a time-domain electromagnetic transmitter emits electromagnetic radiation based on the time-domain electromagnetic parameters; and fusing, using the at least one hardware processor, the obtained data to generate a subsurface model.

Embodiment 2: The computer implemented method of any preceding embodiment, including: updating the subsurface model in real-time using data obtained in real-time; and predicting drilling hazards in real time based on the updated subsurface model.

Embodiment 3: The computer implemented method of any preceding embodiment, including converting the obtained data into images that show changes in components of magnetic fields.

Embodiment 4: The computer implemented method of any preceding embodiment, including processing the obtained data using image-based real-time drilling hazard detection via an image based machine learning model to generate the subsurface model.

Embodiment 5: The computer implemented method of any preceding embodiment, including evaluating the subsurface model using physics-based machine learning to confirm at least one drilling hazard in an environment.

Embodiment 6: The computer implemented method of any preceding embodiment, including emitting transient electromagnetic pulses into the subsurface without galvanic contact.

Embodiment 7: The computer implemented method of any preceding embodiment, including moving the time-domain electromagnetic transmitter during data capture to enable adaptable data acquisition.

Embodiment 8: An apparatus including a non-transitory, computer readable, storage medium that stores instructions that, when executed by at least one processor, cause the at least one processor to perform operations including: determining time-domain electromagnetic parameters; obtaining data at multiple heights by at least one unmanned aerial vehicle equipped with at least one receiver as a time-domain electromagnetic transmitter emits electromagnetic radiation based on the time-domain electromagnetic parameters; and fusing the obtained data to generate a subsurface model.

Embodiment 9: The apparatus of any preceding embodiment, wherein the operations comprise: updating the subsurface model in real-time using data obtained in real-time; and predicting drilling hazards in real time based on the updated subsurface model.

Embodiment 10: The apparatus of any preceding embodiment, wherein the obtained data is converted into images that show changes in components of magnetic fields.

Embodiment 11: The apparatus of any preceding embodiment, wherein the obtained data is processed using image-based real-time drilling hazard detection via an image based machine learning model to generate the subsurface model.

Embodiment 12: The apparatus of any preceding embodiment, wherein the subsurface model is evaluated using physics-based machine learning to confirm at least one drilling hazard in an environment.

Embodiment 13: The apparatus of any preceding embodiment, wherein the time-domain electromagnetic transmitter emits transient electromagnetic pulses into the subsurface without galvanic contact.

Embodiment 14: The apparatus of any preceding embodiment, wherein the time-domain electromagnetic transmitter moves during data capture to enable adaptable data acquisition.

Embodiment 15: A system, including: one or more memory modules; one or more hardware processors communicably coupled to the one or more memory modules, the one or more hardware processors configured to execute instructions stored on the one or more memory models to perform operations including: determining time-domain electromagnetic parameters; obtaining data at multiple heights by at least one unmanned aerial vehicle equipped with at least one receiver as a time-domain electromagnetic transmitter emits electromagnetic radiation based on the time-domain electromagnetic parameters; and fusing the obtained data to generate a subsurface model.

Embodiment 16: The system of any preceding embodiment, wherein the operations comprise: updating the subsurface model in real-time using data obtained in real-time; and predicting drilling hazards in real time based on the updated subsurface model.

Embodiment 17: The system of any preceding embodiment, wherein the obtained data is converted into images that show changes in components of magnetic fields.

Embodiment 18: The system of any preceding embodiment, wherein the obtained data is processed using image-based real-time drilling hazard detection via an image based machine learning model to generate the subsurface model.

Embodiment 19: The system of any preceding embodiment, wherein the subsurface model is evaluated using physics-based machine learning to confirm at least one drilling hazard in an environment.

Embodiment 20: The system of any preceding embodiment, wherein the time-domain electromagnetic transmitter emits transient electromagnetic pulses into the subsurface without galvanic contact.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user.

Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method: a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables detection and mitigation of drilling hazards, comprising:
determining, using at least one hardware processor, time-domain electromagnetic parameters;
obtaining, using the at least one hardware processor, data at multiple heights by at least one unmanned aerial vehicle equipped with at least one receiver as a time-domain electromagnetic transmitter emits electromagnetic radiation based on the time-domain electromagnetic parameters; and
fusing, using the at least one hardware processor, the obtained data to generate a subsurface model.

2. The computer implemented method of claim 1, comprising:
updating the subsurface model in real-time using data obtained in real-time; and
predicting drilling hazards in real time based on the updated subsurface model.

3. The computer implemented method of claim 1, comprising converting the obtained data into images that show changes in components of magnetic fields.

4. The computer implemented method of claim 1, comprising processing the obtained data using image-based real-time drilling hazard detection via an image based machine learning model to generate the subsurface model.

5. The computer implemented method of claim 1, comprising evaluating the subsurface model using physics-based machine learning to confirm at least one drilling hazard in an environment.

6. The computer implemented method of claim 1, comprising emitting transient electromagnetic pulses into the subsurface without galvanic contact.

7. The computer implemented method of claim 1, comprising moving the time-domain electromagnetic transmitter during data capture to enable adaptable data acquisition.

8. An apparatus comprising a non-transitory, computer readable, storage medium that stores instructions that, when executed by at least one processor, cause the at least one processor to perform operations comprising:
determining time-domain electromagnetic parameters;
obtaining data at multiple heights by at least one unmanned aerial vehicle equipped with at least one receiver as a time-domain electromagnetic transmitter emits electromagnetic radiation based on the time-domain electromagnetic parameters; and
fusing the obtained data to generate a subsurface model.

9. The apparatus of claim 8, wherein the operations comprise:
updating the subsurface model in real-time using data obtained in real-time; and
predicting drilling hazards in real time based on the updated subsurface model.

10. The apparatus of claim 8, wherein the obtained data is converted into images that show changes in components of magnetic fields.

11. The apparatus of claim 8, wherein the obtained data is processed using image-based real-time drilling hazard detection via an image based machine learning model to generate the subsurface model.

12. The apparatus of claim 8, wherein the subsurface model is evaluated using physics-based machine learning to confirm at least one drilling hazard in an environment.

13. The apparatus of claim 8, wherein the time-domain electromagnetic transmitter emits transient electromagnetic pulses into the subsurface without galvanic contact.

14. The apparatus of claim 8, wherein the time-domain electromagnetic transmitter moves during data capture to enable adaptable data acquisition.

15. A system, comprising:
one or more memory modules;
one or more hardware processors communicably coupled to the one or more memory modules, the one or more hardware processors configured to execute instructions stored on the one or more memory models to perform operations comprising:
determining time-domain electromagnetic parameters;
obtaining data at multiple heights by at least one unmanned aerial vehicle equipped with at least one receiver as a time-domain electromagnetic transmitter emits electromagnetic radiation based on the time-domain electromagnetic parameters; and
fusing the obtained data to generate a subsurface model.

16. The system of claim 15, wherein the operations comprise:
updating the subsurface model in real-time using data obtained in real-time; and
predicting drilling hazards in real time based on the updated subsurface model.

17. The system of claim 15, wherein the obtained data is converted into images that show changes in components of magnetic fields.

18. The system of claim 15, wherein the obtained data is processed using image-based real-time drilling hazard detection via an image based machine learning model to generate the subsurface model.

19. The system of claim 15, wherein the subsurface model is evaluated using physics-based machine learning to confirm at least one drilling hazard in an environment.

20. The system of claim 15, wherein the time-domain electromagnetic transmitter emits transient electromagnetic pulses into the subsurface without galvanic contact.
